(19) United States
(12) Patent Application Publication
(10) Pub. No.: US 2018/0272286 A1
(43) Pub. Date: Sep. 27, 2018

(54) PROCESS FOR MAKING MEMBRANES

(71) Applicant: BASF SE, Ludwigshafen am Rhein (DE)

(72) Inventors: Oliver GRONWALD, Heusenstamm (DE); Martin WEBER, Maikammer (DE); Hartwig VOSS, Frankenthal (DE); Martin HEIJNEN, Landsberg am Lech (DE)

(73) Assignee: BASF SE, Ludwigshafen am Rhein (DE)

(21) Appl. No.: 15/758,599

(22) PCT Filed: Sep. 7, 2016
(86) PCT No.: PCT/EP2016/071061

§ 371 Date: Mar. 8, 2018

(30) Foreign Application Priority Data
Sep. 17, 2015 (EP) 15185602.8

(51) Int. Cl. B01D 67/00; B01D 69/12; B01D 71/68; B01D 69/02

(52) U.S. Cl. CPC B01D 67/0016; B01D 69/12; B01D 67/0013; B01D 67/003; B01D 71/68; B01D 2323/18; B01D 2323/02; B01D 2323/06; B01D 2323/12; B01D 2325/34; B01D 2325/36; B01D 69/02

(57) ABSTRACT

A membrane contains a polymer composition is described. The polymer composition contains a) at least one polymer of PA, PVA, Cellulose CA, CTA, CA-triacetate blend, cellulose ester, cellulose nitrate, regenerated cellulose, aromatic, aromatic/aliphatic or aliphatic polyamide, aromatic, aromatic/aliphatic or aliphatic polyimide, PBI, PBIL, PAN, PAN-PVC copolymer, PAN-methallyl sulfonate copolymer, PEI, PEEK, sulfonated SPEEK, PPO, poly-carbonate, polyester, PTFE, PVDF, PP, a polyelectrolyte complex, PMMA, PDMS, aromatic, aromatic/aliphatic or aliphatic polyimide urethane, aromatic, aromatic/aliphatic or aliphatic polyamidimide, crosslinked polyimide or poly-arylene ether, PSU, PPSU and PESU, and b) at least one dope polymer DP1, which is a polyalkylene oxide with a molecular mass Mw of more than 100,000 g/mol and/or a K-value of 60 or 20 more.

The present invention is related to membranes M comprising a polymer composition comprising
a) at least one polymer P selected from polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBI L), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU), or mixtures thereof,
b) at least one dope polymer DP1, said at least one dope polymer DP1 being polyalkylene oxide with a molecular mass MW of more than 100,000 g/mol.

The present invention is further related to processes for making membranes M and for uses of membranes M.

Different types of membranes play an increasingly important role in many fields of technology. In particular, methods for treating water rely more and more on membrane technology.

For the preparation of porous membranes polymer solutions in polar, protic solvents such as N-methylpyrrolidone are used. It is known in the art to use a second polymer additive in order to adjust the properties of the dope solution and the membrane. Normally, said second polymer additive has to form a homogenous, coherent blend with the polymer P in solution but must be also soluble in the coagulation bath [Desalination, 1988, 70, 265-275].

Lower molecular weight polyethyleneoxides (Mw<20000 g/mol) [Journal Membrane Science 2009, 327, 125-135; Desalination 2011, 272, 51-58] have been disclosed as alternatives for polyvinyl pyrrolidone as second polymer additives in the dope solution [EP2557111].

There is a need for membranes with improved separation characteristics.

It was therefore an objective of the present invention to provide membranes with improved permeabilities, separation performance and fouling properties.

In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through, while retaining others.

For example, membranes M can be reverse osmosis (RO) membranes, forward osmosis (FO) membranes, nanofiltration (NF) membranes, ultrafiltration (UF) membranes or microfiltration (MF) membranes. These membrane types are generally known in the art and are further described below.

FO membranes are normally suitable for treatment of seawater, brackish water, sewage or sludge streams. Thereby pure water is removed from those streams through a FO membrane into a so called draw solution on the back side of the membrane having a high osmotic pressure.

In a preferred embodiment, suitable FO membranes are thin film composite (TFC) FO membranes. Preparation methods and use of thin film composite membranes are principally known and, for example described by R. J. Petersen in Journal of Membrane Science 83 (1993) 81-150.

In a particularly preferred embodiment, suitable FO membranes comprise a fabric layer, a support layer, a separation layer and optionally a protective layer. Said protective layer can be considered an additional coating to smoothen and/or hydrophilize the surface.

Said fabric layer can for example have a thickness of 10 to 500 μm. Said fabric layer can for example be a woven or nonwoven, for example a polyester nonwoven.

Said support layer of a TFC FO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as the main component a polysulfone, polyethersulfone, polyphenylenesulfone, polyvinylidenedifluoride, polyimide, polyimideurethane or cellulose acetate blended with at least one dope polymer DP1 and optionally at least one second dope polymer DP2.

Membranes according to the invention are especially suitable as the support layer of FO membranes.

In one embodiment, FO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU), or mixtures thereof blended with at least one dope polymer DP1 and optionally at least one second dope polymer DP2.

Said separation layer of a FO membrane can for example have a thickness of 0.05 to 1 μm, preferably 0.1 to 0.5 μm, more preferably 0.15 to 0.3 μm. preferably, said separation layer can for example comprise polyamide or cellulose acetate as the main component.

Optionally, TFC FO membranes can comprise a protective layer with a thickness of 30-500 preferable 100-300 nm. Said protective layer can for example comprise polyvinylalcohol (PVA) as the main component. In one embodiment, the protective layer comprises a halamine like chloramine.

In one preferred embodiment, suitable membranes are TFC FO membranes comprising a support layer comprising at least one polysulfone, polyphenylenesulfone and/or polyethersulfone blended with at least one dope polymer DP1 and optionally at least one second dope polymer DP2, a separation layer comprising polyamide as main component and optionally a protective layer comprising polyvinylalcohol as the main component.

In a preferred embodiment suitable FO membranes comprise a separation layer obtained from the condensation of a polyamine and a polyfunctional acyl halide. Said separation layer can for example be obtained in an interfacial polymerization process.

RO membranes are normally suitable for removing molecules and ions, in particular monovalent ions. Typically, RO membranes are separating mixtures based on a solution/diffusion mechanism.

In a preferred embodiment, suitable membranes are thin film composite (TFC) RO membranes. Preparation methods and use of thin film composite membranes are principally known and, for example described by R. J. Petersen in Journal of Membrane Science 83 (1993) 81-150.

In a further preferred embodiment, suitable RO membranes comprise a fabric layer, a support layer, a separation layer and optionally a protective layer. Said protective layer can be considered an additional coating to smoothen and/or hydrophilize the surface

Said fabric layer can for example have a thickness of 10 to 500 μm. Said fabric layer can for example be a woven or nonwoven, for example a polyester nonwoven.

Said support layer of a TFC RO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as the main component a polysulfone, polyethersulfone, polyphenylenesulfone, PVDF, polyimide, polyimideurethane or cellulose acetate blended with at least one dope polymer DP1 and optionally at least one second dope polymer DP2.

In one embodiment, RO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof, blended with at least one dope polymer DP1 and optionally at least one second dope polymer DP2.

In another preferred embodiment, RO membranes comprise a support layer comprising as the main component at least one polysulfone, polyphenylenesulfone and/or polyethersulfone blended with at least one dope polymer DP1 and optionally at least one second dope polymer DP2. Membranes according to the invention are especially suitable for the support layer of RO membranes.

Said separation layer can for example have a thickness of 0.02 to 1 μm, preferably 0.03 to 0.5 μm, more preferably 0.05 to 0.3 μm. Preferably said separation layer can for example comprise polyamide or cellulose acetate as the main component.

Optionally, TFC RO membranes can comprise a protective layer with a thickness of 5 to 500 preferable 10 to 300 nm. Said protective layer can for example comprise polyvinylalcohol (PVA) as the main component. In one embodiment, the protective layer comprises a halamine like chloramine.

In one preferred embodiment, suitable membranes are TFC RO membranes comprising a nonwoven polyester fabric, a support layer comprising at least one polysulfone, polyphenylenesulfone and/or polyethersulfone blended with at least one dope polymer DP1 and optionally at least one second dope polymer DP2, a separation layer comprising polyamide as main component and optionally a protective layer comprising polyvinylalcohol as the main component.

In a preferred embodiment suitable RO membranes comprise a separation layer obtained from the condensation of a polyamine and a polyfunctional acyl halide. Said separation layer can for example be obtained in an interfacial polymerization process.

Suitable polyamine monomers can have primary or secondary amino groups and can be aromatic (e. g. a diaminobenzene, a triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e. g. ethylenediamine, propylenediamine, piperazine, and tris(2-diaminoethyl)amine).

Suitable polyfunctional acyl halides include trimesoyl chloride (TMC), trimellitic acid chloride, isophthaloyl chloride, terephthaloyl chloride and similar compounds or blends of suitable acyl halides. As a further example, the second monomer can be a phthaloyl halide.

In one embodiment of the invention, a separation layer of polyamide is made from the reaction of an aqueous solution of meta-phenylene diamine MPD with a solution of trimesoyl chloride (TMC) in an apolar solvent.

NF membranes are normally especially suitable for removing multivalent ions and large monovalent ions. Typically, NF membranes function through a solution/diffusion or/and filtration-based mechanism.

NF membranes are normally used in crossflow filtration processes.

In one embodiment, NF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Poly-propylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof, blended with at least one dope polymer DP1 and optionally at least one second dope polymer DP2.

In another embodiment of the invention, NF membranes comprise as the main component at least one polysulfone, polyphenylenesulfone and/or polyethersulfone, blended with at least one dope polymer DP1 and optionally at least one second dope polymer DP2.

In a particularly preferred embodiment, the main components of a NF membrane are positively or negatively charged.

Nanofiltration membranes often comprise charged polymers comprising sulfonic acid groups, carboxylic acid groups and/or ammonium groups in combination with block copolymers according to the invention.

In another embodiment, NF membranes comprise as the main component polyamides, polyimides or polyimide urethanes, Polyetheretherketone (PEEK) or sulfonated polyetheretherketone (SPEEK).

UF membranes are normally suitable for removing suspended solid particles and solutes of high molecular weight, for example above 10000 Da. In particular, UF membranes are normally suitable for removing bacteria and viruses.

UF membranes normally have an average pore diameter of 2 nm to 50 nm, preferably 5 to 40 nm, more preferably 5 to 20 nm.

In one embodiment, UF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone, or polyethersulfone, or mixtures thereof, blended with at least one dope polymer DP1 and optionally at least one second dope polymer DP2.

In another embodiment of the invention, UF membranes comprise as the main component at least one polysulfone, polyphenylenesulfone and/or polyethersulfone, blended with at least one dope polymer DP1 and optionally at least one second dope polymer DP2.

“Polysulfones”, “polyethersulfones” and “polyphenylenesulfones” shall include the respective polymers that comprise sulfonic acid and/or salts of sulfonic acid at some of the aromatic moieties.

In one embodiment, UF membranes comprise as the main component or as an additive at least one partly sulfonated polysulfone, partly sulfonated polyphenylenesulfone and/or partly sulfonated polyethersulfone. In one embodiment, UF membranes comprise as the main component or as an additive at least one partly sulfonated polyphenylenesulfone.

“Arylene ethers”, “Polysulfones”, “polyethersulfones” and “polyphenylenesulfones” shall include block polymers that comprise blocks of the respective arylene ethers, Polysulfones, polyethersulfones or polyphenylenesulfones as well as other polymer blocks.

In one embodiment, UF membranes comprise as the main component or as an additive at least one block copolymer of at least one arylene ether and at least one polyalkylene oxide. In one embodiment, UF membranes comprise as the main component or as an additive at least one block copolymer of at least one polysulfone or polyethersulfone and at least one polyalkylene oxide like polyethylene oxide.

In one embodiment, UF membranes comprise further additives like polyvinyl pyrrolidones.

In one embodiment of the invention, UF membranes are present as spiral wound membranes, as pillows or flat sheet membranes.

In another embodiment of the invention, UF membranes are present as tubular membranes.

In another embodiment of the invention, UF membranes are present as hollow fiber membranes or capillaries.

In yet another embodiment of the invention, UF membranes are present as single bore hollow fiber membranes.

In yet another embodiment of the invention, UF membranes are present as multibore hollow fiber membranes.

Multiple channel membranes, also referred to as multibore membranes, comprise more than one longitudinal channels also referred to simply as “channels”.

In a preferred embodiment, the number of channels is typically 2 to 19. In one embodiment, multiple channel membranes comprise two or three channels. In another embodiment, multiple channel membranes comprise 5 to 9 channels. In one preferred embodiment, multiple channel membranes comprise seven channels.

In another embodiment the number of channels is 20 to 100.

The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter.

In some cases, the actual form of such channels may deviate from the idealized circular, ellipsoid or rectangular form.

Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm.

For channels with an essentially rectangular shape, these channels can be arranged in a row.

For channels with an essentially circular shape, these channels are in a preferred embodiment arranged such that a central channel is surrounded by the other channels. In one preferred embodiment, a membrane comprises one central channel and for example four, six or 18 further channels arranged cyclically around the central channel.

The wall thickness in such multiple channel membranes is normally from 0.02 to 1 mm at the thinnest position, preferably 30 to 500 μm, more preferably 100 to 300 μm.

Normally, the membranes according to the invention and carrier membranes have an essentially circular, ellipsoid or rectangular diameter. Preferably, membranes according to the invention are essentially circular.

In one preferred embodiment, membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm.

In another preferred embodiment, membranes according to the invention have a diameter (for essentially circular diameters), smaller diameter (for essentially ellipsoid diameters) or smaller feed size (for essentially rectangular diameters) of 2 to 4 mm.

In one embodiment the rejection layer is located on the inside of each channel of said multiple channel membrane.

In one embodiment, the channels of a multibore membrane may incorporate an active layer with a pore size different to that of the carrier membrane or a coated layer forming the active layer. Suitable materials for the coated layer are polyoxazoline, polyethylene glycol, polystyrene, hydrogels, polyamide, zwitterionic block copolymers, such as sulfobetaine or carboxybetaine. The active layer can have a thickness in the range from 10 to 500 nm, preferably from 50 to 300 nm, more preferably from 70 to 200 nm.

In one embodiment multibore membranes are designed with pore sizes between 0.2 and 0.01 μm. In such embodiments the inner diameter of the capillaries can lie between 0.1 and 8 mm, preferably between 0.5 and 4 mm and particularly preferably between 0.9 and 1.5 mm. The outer diameter of the multibore membrane can for example lie between 1 and 26 mm, preferred 2.3 and 14 mm and particularly preferred between 3.6 and 6 mm. Furthermore, the multibore membrane can contain 2 to 94, preferably 3 to 19 and particularly preferred between 3 and 14 channels. Often multibore membranes contain seven channels. The permeability range can for example lie between 100 and 10000 L/m² hbar, preferably between 300 and 2000 L/m² hbar.

Typically multibore membranes of the type described above are manufactured by extruding a polymer, which forms a semi-permeable membrane after coagulation through an extrusion nozzle with several hollow needles. A coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent. As a result a membrane can be obtained that has an active layer inside the channels and an outer surface, which exhibits no or hardly any resistance against liquid flow. Herein suitable coagulation agents include solvents and/or non-solvents. The strength of the coagulations may be adjusted by the combination and ratio of non-solvent/solvent. Coagulation solvents are known to the person skilled in the art and can be adjusted by routine experiments. An example for a solvent based coagulation agent is N-methylpyrrolidone. Non-solvent based coagulation agents are for instance water, iso-propanol and propylene glycol.

MF membranes are normally suitable for removing particles with a particle size of 0.1 μm and above.

MF membranes normally have an average pore diameter of 0.05 μm to 10 μm, preferably 1.0 μm to 5 μm.

Microfiltration can use a pressurized system but it does not need to include pressure.

MF membranes can be capillaries, hollow fibers, flat sheet, tubular, spiral wound, pillows, hollow fine fiber or track etched. They are porous and allow water, monovalent species (Na+, Cl−), dissolved organic matter, small colloids and viruses through but retain particles, sediment, algae or large bacteria.

Microfiltration systems are designed to remove suspended solids down to 0.1 micrometers in size, in a feed solution with up to 2-3% in concentration.

In one embodiment, MF membranes comprise as the main component at least polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone, or mixtures thereof, blended with at least one dope polymer DP1 and optionally at least one second dope polymer DP2.

In another embodiment of the invention, MF membranes comprise as the main component or as an additive at least one polysulfone, polyphenylenesulfone and/or polyethersulfone, blended with at least one dope polymer DP1 and optionally at least one second dope polymer DP2. In one embodiment, MF membranes comprise as the main component or as an additive at least one partly sulfonated polysulfone, partly sulfonated polyphenylenesulfone and/or partly sulfonated polyethersulfone. In one embodiment, UF membranes comprise as the main component or as an additive at least one partly sulfonated polyphenylenesulfone.

In one embodiment, MF membranes comprise as the main component or as an additive at least one block copolymer of at least one arylene ether and at least one polyalkylene oxide. In one embodiment, MF membranes comprise as the main component or as an additive at least one block copolymer of at least one polysulfone or polyethersulfone and at least one polyalkylene oxide like polyethylene oxide.

Membranes M comprise as component a) at least one polymer P selected from polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU), or mixtures thereof.

Preferably, polymer P is selected from poly(vinylidene fluoride) (PVDF), polyarylene ether, polysulfone (PSU), polyphenylenesulfone (PPSU) or polyethersulfone (PESU). In one especially preferred embodiment, polymer P is polyethersulfone,

In one embodiment, membranes M comprise as the main component or as an additive at least one polymer P that is a partly sulfonated polysulfone, partly sulfonated polyphenylenesulfone and/or partly sulfonated polyethersulfone. In one embodiment, membranes M comprise as the main component at least one partly sulfonated polyphenylenesulfone.

In one embodiment, membranes M comprise as the main component or as an additive at least one polymer P that is a block copolymer of at least one arylene ether and at least one polyalkylene oxide. In one embodiment, membranes M comprise as the main component or as an additive at least one block copolymer of at least one polysulfone or polyethersulfone and at least one polyalkylene oxide like polyethylene oxide.

Within membrane M, all components described herein are comprised in the same layer of the membrane, that is in one polymer composition.

Membranes M further comprise a component b) at least one dope polymer DP1, said at least one dope polymer DP1 being polyalkylene oxide with a molecular mass M_{W} of more than 100,000 g/mol.

Preferably, said at least one dope polymer DP1 has a molar mass M_{W} of 100 kDa to 600 kDa.

In one embodiment, said at least one dope polymer DP1 has a molar mass Mw of 100 kDa to 400 kDa.

In one embodiment, said at least one dope polymer DP1 has a molar mass Mw of 300 kDa to 600 kDa.

In one embodiment, said at least one dope polymer DP1 is a polyalkylene oxide with a K-value of 60 to 200.

In one embodiment, said at least one dope polymer DP1 is a polyalkylene oxide with a K-value of 60 to 90.

In one embodiment, said at least one dope polymer DP1 is a polyalkylene oxide with a K-value of 80 to 120.

Methods for determining the molecular mass Mw of dope polymers DP1 and DP2 as well as of their K-value are given in the experimental section.

The molar mass Mw of dope polymers DP1 can be determined by gel permeation chromatography as described in the experimental section.

Polyalkylene oxides suitable as dope polymers DP1 (herein referred to a as “polyalkylene oxides DP1”) are particularly polyethers of diols. Suitable polyalkylene oxides are normally produced by polymerization of at least one alkylene oxide. Suitable monomeric alkylene oxides are for example ethylene oxide or substituted ethylene oxides bearing one or more alkyl and/or aryl groups. Suitable monomeric alkylene oxides are for example styrene oxide or C₂-C₂₀-alkylene oxides, such as ethylene oxide, propylene oxide, 1,2-butylene oxide, 2,3-butylene oxide, isobutylene oxide, pentene oxide, hexene oxide, cyclohexene oxide, dodecene epoxide, octadecene epoxide. Ethylene oxide, propylene oxide, 1,2-butylene oxide, 2,3-butylene oxide, isobutylene oxide and pentene oxide are particularly suitable, propylene oxide and ethylene oxide being particularly preferred.

Polyalkylene oxides DP1 can be homopolymers or copolymers.

In one embodiment, polyalkylene oxides DP1 are copolymers of at least two different alkylene oxides. In one embodiment, polyalkylene oxides DP1 are statistical copolymers of at least two different alkylene oxides. In another embodiment, polyalkylene oxides DP1 are block copolymers of at least two different alkylene oxides.

In one preferred embodiment, polyalkylene oxides DP1 are homopolymers of ethyleneoxide (“polyethylene oxide”).

In one preferred embodiment, polyalkylene oxides DP1 are homopolymers of propylene oxide (“polypropylene oxide”).

In one embodiment, polyalkylene oxides DP1 are statistical copolymers of ethylene oxide and propylene oxide.

In one embodiment, polyalkylene oxides DP1 are block copolymers of ethylene oxide and propylene oxide.

Polyalkylene oxides DP1 can be linear or branched. Branching of a polyalkylene oxide can for example be achieved by including monomers bearing an epoxide group and an OH or a chloro moiety into the polyalkylene oxide. Preferably, polyalkylene oxides DP1 are linear.

Normally said at least one dope polymer DP1 is comprised in membrane M in an amount of 0.1 to 20% by weight relative to the membrane M, preferably 0.2 to 15% by weight, more preferably 1 to 15% by weight. In one embodiment said at least one dope polymer DP1 is comprised in membrane M in an amount of 8 to 15% by weight relative to the membrane M.

In one embodiment, membranes M comprise dope polymers DP1 having a bimodal mass distribution.

In case membrane M is a composite membrane comprising more than one layer, the content of dope polymer DP1 and second dope polymer DP2 shall be calculated based on the polymer composition forming the layer that comprises polymer P, with which dope polymers DP1 and DP2 are blended.

Membranes M comprise said at least one polymer P and dope polymers DP1 and optionally DP2 as a mixture (a blend).

Membranes M comprise said at least one polymer P and dope polymers DP1 and optionally DP2 in the same layer of membrane M.

In one embodiment, membranes M comprise said at least one polymer P and dope polymers DP1 and optionally DP2 as a homogenous mixture.

In one embodiment, membranes M comprise said at least one polymer P and dope polymers DP1 and optionally DP2 in the same layer of said membrane, wherein said at said dope polymers DP1 and optionally DP2 are enriched on the surface of membrane M. “Surface” in this context is understood to mean the top layer of the surface with a depth of 10 nm.

Membranes M can optionally further comprise at least one second dope polymer DP2.

Second dope polymer DP2 can for example be selected from polyalkylene oxide with a molecular mass Mw below 100,000 g/mol, polyvinylpyrrolidone or mixtures thereof.

In one embodiment said at least one second dope polymer DP2 is a polyalkylene oxide with a molar mass M_{W} of less than 100,000 g/mol.

Polyalkylene oxides DP2 have a molar mass M_{W} of less than 100 kDa, preferably 300 Da to 50 kDa and more preferably 1000 Da to 30 kDa.

In one embodiment, polyalkylene oxide DP2 have a molar mass Mw of 30 kDa to 50 kDa.

In one embodiment polyalkylene oxide DP2 comprises 1 to 500 alkyleneoxide units. Preferably, suitable polyalkylene oxides comprise 2 to 300, more preferably 3 to 150, even more preferably 5 to 100 and especially preferably 10 to 80 alkylene oxide units.

In one embodiment, said at least one dope polymer DP2 is a polyalkylene oxide with a K-value of 1 to 59.

In one embodiment, said at least one dope polymer DP2 is a polyalkylene oxide with a K-value of 20 to 50.

Polyalkylene oxides suitable as dope polymers DP2 (herein referred to a as “polyalkylene oxides DP2”) are particularly polyethers of diols. Suitable polyalkylene oxides are normally produced by polymerization of at least one alkylene oxide. Suitable monomeric alkylene oxides are for example ethylene oxide or substituted ethylene oxides bearing one or more alkyl and/or aryl groups. Suitable monomeric alkylene oxides are for example styrene oxide or C₂-C₂₀-alkylene oxides, such as ethylene oxide, propylene oxide, 1,2-butylene oxide, 2,3-butylene oxide, isobutylene oxide, pentene oxide, hexene oxide, cyclohexene oxide, dodecene epoxide, octadecene epoxide. Ethylene oxide, propylene oxide, 1,2-butylene oxide, 2,3-butylene oxide, isobutylene oxide and pentene oxide are particularly suitable, propylene oxide and ethylene oxide being particularly preferred.

Polyalkylene oxides DP2 can be homopolymers or copolymers.

In one embodiment, polyalkylene oxides DP2 are copolymers of at least two different alkylene oxides. In one embodiment, polyalkylene oxides DP2 are statistical copolymers of at least two different alkylene oxides. In another embodiment, polyalkylene oxides DP2 are block copolymers of at least two different alkylene oxides.

In one preferred embodiment, polyalkylene oxides DP2 are homopolymers of ethyleneoxide (“polyethylene oxide”).

In one preferred embodiment, polyalkylene oxides DP2 are homopolymers of propylene oxide (“polypropylene oxide”).

In one embodiment, polyalkylene oxides DP2 are statistical copolymers of ethylene oxide and propylene oxide.

In one embodiment, polyalkylene oxides DP2 are block copolymers of ethylene oxide and propylene oxide.

Polyalkylene oxides DP2 can be linear or branched. Branching of a polyalkylene oxide can for example be achieved by including monomers bearing an epoxide group and an OH or a chloro moiety into the polyalkylene oxide. Preferably, polyalkylene oxides DP2 are linear.

In one embodiment, said at least one second dope polymer DP2 is polyvinylpyrrolidone.

Polyvinylpyrrolidone DP2 normally has a molar mass MW of 5000 to 1,500,000 g/mol.

In one embodiment Polyvinylpyrrolidone DP2 has a K-value of 10 to 120, preferably of 25 to 100.

Normally dope polymer DP2 is comprised in membrane M in an amount of 0.1 to 19.9 or 20% by weight relative to membrane M, preferably 0.2 to 16% by weight, more preferably 1 to 16% by weight, with the proviso that the combined amount of dope polymers DP1 and second dope polymers DP2 does not exceed 20% by weight relative to membrane M. In one embodiment said at least one dope polymer DP2 is comprised in membrane M in an amount of 8 to 15% by weight relative to the membrane M.

Normally said second dope polymer DP2 is comprised in said polymer composition in an amount of 0.1 to 16% by weight relative to the polymer composition with the proviso that the combined amount of dope polymer DP1 and second dope polymer DP2 is from 0.2% by weight to 16% by weight.

In one embodiment, membranes M comprise 0.1 to 20% by weight relative to membrane M, preferably 0.2 to 16% by weight, more preferably 8 to 16% or by weight of at least one dope polymer DP1 and no second dope polymer DP2.

In one embodiment, membranes M comprise 0.1 to 20% by weight relative to membrane M, preferably 0.2 to 16% by weight, more preferably 8 to 16% or by weight of a bimodal distribution of dope polymers DP1 and no second dope polymer DP2.

In one embodiment, membranes M comprise 1 to 8% by weight of at least one dope polymer DP1 and 1 to 8% by weight of at least one second dope polymer DP2.

In one embodiment, membranes M comprise 1 to 8% by weight of at least one dope polymer DP1 selected from at least one polyethylene oxide with a molar mass M_{W} of more than 100 kDa and 1 to 8% by weight of at least one second dope polymer DP2 selected from polyethylene oxide with a molar mass of 300 to 50,000 g/mol and no further second dope polymers DP2.

In one embodiment, membranes M comprise 1 to 8% by weight of at least one dope polymer DP1 selected from at least one polyethylene oxide with a molar mass Mw of more than 100 kDa and 1 to 5% by weight of at least one second dope polymer DP2 selected from polyvinylpyrrolidone with a K-value of 20 to 100 and no further second dope polymers DP2.

In one embodiment, membranes M comprise 1 to 5% by weight of at least one dope polymer DP1 selected from at least one polyethylene oxide with a molar mass M_{W} of more than 100 kDa, 1 to 4.5% by weight of at least one second dope polymer DP2 selected from polyvinylpyrrolidone with a K value of 20 to 100, 1 to 4.5% by weight of at least one second dope polymer DP2 selected from polyethylene oxide with a molar mass of 300 to 50,000 g/mol and no further second dope polymers DP2.

In one embodiment, membranes M comprise 1 to 8% by weight of at least one dope polymer DP1 selected from at least one block copolymer of polyethylene oxide and polypropylene oxide with a molar mass M_{W} of more than 100 kDa and 1 to 8% by weight of at least one second dope polymer DP2 selected from polyethylene oxide with a molar mass of 300 to 50,000 g/mol and no further second dope polymers DP2.

In one embodiment, membranes M comprise 1 to 8% by weight of at least one dope polymer DP1 selected from at least one block copolymer of polyethylene oxide and polypropylene oxide with a molar mass M_{W} of more than 100 kDa and 1 to 5% by weight of at least one second dope polymer DP2 selected from polyvinylpyrrolidone with a K-value of 20 to 100 and no further second dope polymers DP2.

In one embodiment, membranes M comprise 1 to 5% by weight of at least one dope polymer DP1 selected from at least one block copolymer of polyethylene oxide and polypropylene oxide with a molar mass Mw of more than 100 kDa, 1 to 4.5% by weight of at least one second dope polymer DP2 selected from polyvinylpyrrolidone with a K-value of 20 to 100, 1 to 4.5% by weight of at least one second dope polymer DP2 selected from polyethylene oxide with a molar mass of 300 to 50,000 g/mol and no further second dope polymers DP2.

Membranes M have excellent separation characteristics. In particular, membranes M have very good molecular weight cutoffs (MWCO). In a preferred embodiment, membranes M have a molecular weight cutoff, determined as described in the experimental section, of less than 20 kDa. Membranes M further have very good water permeabilities. In a preferred embodiment, membranes M have a pure water permeability (PWP), determined as described in the experimental section, of more than 200 kg/h m² bar, preferably 400 to 800 kg/h m² bar.

Membranes M have very good fouling properties and show only little fouling and biofouling.

Membranes M are storage stable and have a long lifetime.

Membranes M show a low contact angle when contacted with water. Thus, membranes M are easily wettable with water.

Membranes M have a high upper glass transition temperature.

Membranes M are easy to make and to handle, are able to stand high temperatures and can for example be subjected to vapor sterilization.

Furthermore, membranes M have very good dimensional stabilities, high heat distortion resistance, good mechanical properties and good flame retardance properties and biocompatibility. They can be processed and handled at high temperatures, enabling the manufacture of membranes and membrane modules that are exposed to high temperatures and are for example subjected to disinfection using steam, water vapor or higher temperatures, for example above 100° C. of above 125° C.

Membranes M show excellent properties with respect to the decrease of flux through a membrane over time and their fouling and biofouling properties.

Membranes M are easy and economical to make.

Another aspect of the invention are processes for making membranes M.

Processes for making membranes M typically comprise the following steps:
a) providing a dope solution D comprising at least one polymer P, at least one dope polymer DP1 and optionally at least one second dope polymer DP2 and at least one solvent S,
b) adding at least one coagulant C to said dope solution D to coagulate said at least one polymer P from said dope solution D to obtain membrane M.

The term “adding” in step b) shall include “bringing into contact” and shall not differentiate whether coagulant C or a medium comprising coagulant C is added to the dope solution D or dope solution D is added to coagulant C or a medium comprising coagulant C.

Solvent S can be any solvent capable of dissolving all components yet allowing coagulation through addition of a coagulant C.

Typical solvents S include N-methylpyrrolidone, N,N-dimethyl-2-hydroxypropanoic amide, N,N-diethyl-2-hydroxypropanoic amide, alcohols, preferably divalent alcohols or trivalent alcohols like glycerol, or mixtures thereof.

In one embodiment, dope solution D comprises 5 to 30% by weight of polyarylene ether like polyethersulfone, 1 to 10% by weight of accumulated at least one dope polymer DP1 and optionally at least one second dope polymer DP2 and 60 to 94% by weight of at least one solvent S, with the amounts preferably adding up to 100%.

Suitable coagulants C are for example liquid water, water vapor or alcohols.

Manufacturing of membranes M, especially of ultrafiltration membranes M, often includes non-solvent induced phase separation (NIPS).

In the NIPS process, the polymers used as starting materials (e.g. selected from polyvinyl pyrrolidone, vinyl acetates, cellulose acetates, polyacrylonitriles, polyamides, polyolefines, polyesters, polysulfones, polyethersulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyphenylene sulfones, polyvinylidene fluorides, polyamides, cellulose acetate and mixtures thereof, especially including polyether sulfone) as well as said at least one dope polymer DP1 and optionally at least one second dope polymer DP2 are dissolved in at least one solvent S together with any further additive(s) used. In a next step, a porous polymeric membrane is formed under controlled conditions in a coagulation bath. In most cases, the coagulation bath contains water as coagulant, or the coagulation bath is an aqueous medium, wherein the matrix forming polymer is not soluble. The cloud point of the polymer is defined in the ideal ternary phase diagram. In a bimodal phase separation, a microscopic porous architecture is then obtained, and water soluble components (including polymeric additives) are finally found in the aqueous phase.

In case further additives like second dope polymers DP2 are present that are simultaneously compatible with the coagulant and the matrix polymer(s), segregation on the surface results. With the surface segregation, an enrichment of the certain additives is observed. The membrane surface thus offers new (hydrophilic) properties compared to the primarily matrix-forming polymer, the phase separation induced enrichment of the additive of the invention leading to antiadhesive surface structures.

A typical process for the preparation of a solution to prepare membranes M comprises the following steps:

a) providing a dope solution D comprising at least one polymer P, at least one dope polymer DP1 and optionally at least one second dope polymer DP2 and at least one solvent S,

a2) optionally heating the mixture until a viscous solution is obtained; typically temperature of the dope solution D is 5-250° C., preferably 25-150° C., more preferably 50-90° C.,

a3) optionally stirring of the solution/suspension until a mixture is formed within 1-15 h, typically the homogenization is finalized within 2 h,

a4) optionally removing gases dissolved or present in the solution by applying a vacuum,

b) Casting the membrane dope in a coagulation bath to obtain a membrane structure. Optionally the casting can be outlined using a polymeric support (non-woven) for stabilizing the membrane structure mechanically.

In one embodiment a process for the preparation of a solution to prepare membranes M comprises the following steps:

a) providing a dope solution D comprising at least one polymer P, at least one dope polymer DP1 and optionally at least one second dope polymer DP2 and at least one solvent S,

a2) adjusting the temperature of the mixture until a viscous solution is obtained; typically temperature of the dope solution D is 5-250° C., preferably 25-150° C., more preferably 50-90° C.,

a3) stirring of the solution/suspension until a mixture is formed within 1-15 h, typically the homogenization is finalized within 2 h,

a4) removing gases dissolved or present in the solution by applying a vacuum,

b) Casting the membrane dope in a coagulation bath to obtain a membrane structure. Optionally the casting can be outlined using a polymeric support (non-woven) for stabilizing the membrane structure mechanically.

In one embodiment, hollow fiber membranes or multibore membranes (multichannel hollow fiber membranes) are manufactured by extruding a polymer, which forms a semi-permeable membrane after coagulation through an extrusion nozzle with several hollow needles. A coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent. As a result a membrane can be obtained that has an active layer inside the channels and an outer surface, which exhibits no or hardly any resistance against liquid flow. Herein suitable coagulation agents include solvents and/or non-solvents. The strength of the coagulations may be adjusted by the combination and ratio of non-solvent/solvent. Coagulation solvents are known to the person skilled in the art and can be adjusted by routine experiments. An example for a solvent based coagulation agent is N-methylpyrrolidone. Non-solvent based coagulation agents are for instance water, methanol, ethanol, n-propanol, iso-propanol, n-butanol, sec.-butanol, iso-butanol, n-pentanol, sec.-pentanol, iso-pentanol, 1,2-ethanediol, ethylene glycol, diethylene glycol, triethylene glycol, propyleneglycol, dipropyleneglycol, glycerol, neopentylglycol, 1,4-butanediol, 1,5-pentanediol, pentaerythritol.

Optionally processes according to the invention can be followed by further process steps. For example such processes may include c) oxidative treatment of the membrane previously obtained, for example using sodium hypochlorite. Processes according to the invention may further comprise d) washing of the membrane with water.

Processes according to the invention are easy and economical to carry out and allow for the manufacture of membranes M with excellent separation characteristics, mechanical stability and fouling properties.

Another aspect of the invention are dope solutions D comprises 5 to 30% by weight of poly-arylene ether like polyethersulfone, 1 to 10% by weight of accumulated at least one dope polymer DP1 and optionally at least one second dope polymer DP2 and 60 to 94% by weight of at least one solvent S, with the proviso that the amounts add up to 100%.

Another aspect of the invention are membrane elements comprising membranes M.

A “membrane element”, herein also referred to as a “filtration element”, shall be understood to mean a membrane arrangement of at least one single membrane body. A filtration element can either be directly used as a filtration module or be included in a membrane module. A membrane module, herein also referred to as a filtration module, comprises at least one filtration element. A filtration module normally is a ready to use part that in addition to a filtration element comprises further components required to use the filtration module in the desired application, such as a module housing and the connectors. A filtration module shall thus be understood to mean a single unit which can be installed in a membrane system or in a membrane treatment plant. A membrane system herein also referred to as a filtration system is an arrangement of more than one filtration module that are connected to each other. A filtration system is implemented in a membrane treatment plant.

In many cases, filtration elements comprise more than one membrane arrangement and may further comprise more components like an element housing, one or more bypass tubes, one or more baffle plates, one or more perforated inner tubes or one or more filtrate collection tube. For hollow fiber or multibore membranes, for example, a filtration element normally comprises more than one hollow fiber or multibore membrane arrangement that have been fixed to an outer shell or housing by a potting process. Filtration elements that have been subjected to potting can be fixed on one end or on both ends of the membrane arrangement to the outer shell or housing.

In one embodiment, filtration elements or filtration modules according to the invention discharge permeate directly through an opening in the tube housing or indirectly through a discharge tube located within the membrane element. Particularly when indirect discharge is facilitated the discharge tube can for example be placed in the center of the membrane element and the capillaries of the membrane element are arranged in bundles surrounding the discharge tube.

In another embodiment, a filtration element for filtering comprises an element housing, wherein at least one membrane arrangement and at least one permeate collecting tube are arranged within the element housing and wherein the at least one permeate collecting tube is arranged in an outer part of the filtration element.

The permeate collecting tube inside filtration elements or filtration modules may in one embodiment have cylindrical shape, wherein the cross-section may have any shape such as round, oval, triangular, square or some polygon shape. Preferred is a round shape, which leads to enhanced pressure resistance. Preferably the longitudinal center line of the at least one permeate collecting tube is arranged parallel to the longitudinal center line of the membrane element and the element housing. Furthermore, a cross-section of the permeate collecting tube may be chosen according to the permeate volume produced by the membrane element and pressure losses occurring in the permeate collecting tube. The diameter of the permeate collecting tube may be less than half, preferred less than a third and particularly preferred less than a quarter of the diameter of the element housing.

The permeate collecting tube and the membrane element may have different or the same shape. Preferably the permeate collecting tube and the membrane element have the same shape, particularly a round shape. Thus, the at least one permeate collecting tube can be arranged within the circumferential ring extending from the radius of the element housing to half, preferred a third and particularly preferred a quarter of the radius of the element housing.

In one embodiment the permeate collecting tube is located within the filtration element such that the permeate collecting tube at least partially touches the element housing. This allows placing the filtration element in the filtration module or system such that the permeate collecting tube is arranged substantially at the top of the filtration element in horizontal arrangement. In this context substantially at the top includes any position in the outer part of the membrane that lies within ±45°, preferred ±10° from a vertical center axis in a transverse plane of the filtration element. Here the vertical center axis in a transverse plane is perpendicular to the horizontal center axis in the transverse plane and to the longitudinal center axis extending along the long axis of the filtration element. By arranging the permeate collecting tube this way, air residing within the membrane element before start-up of the filtration module or system can be collected in the permeate collecting tube, which can then easily be vented upon start up by starting the filtration operation. In particular, air pockets can be displaced by permeate which is fed to the filtration module or system and filtered by the membrane element on start up. By releasing air from the filtration module or system the active area of the membrane element increases, thus increasing the filtering effect. Furthermore the risk of fouling due to trapped air pockets decreases and pressure surges as well as the risk of breakage of the membrane element are minimized.

In another embodiment of the filtration element at least two permeate collecting tubes may be arranged in the filtration element, particularly within the element housing. By providing more than one permeate collecting tube the output volume of permeate at a constant pressure can be increased and adjusted to the permeate volume produced by the membrane element. Furthermore the pressure loss is reduced if high backwashing flows are required. Here at least one first permeate collecting tube is arranged in the outer part of the filtration element and at least one second permeate collecting tube can be arranged in the inner or the outer part of the filtration element. For example, two permeate collecting tubes may be arranged in the outer part or one first permeate collecting tube may be arranged in the outer part and another second permeate collecting tube may be arranged in the inner part of the filtration element.

Preferably at least two permeate collecting tubes are arranged opposite each other in the outer part or the outer circumferential ring of the filtration element. By providing at least two permeate collecting tubes opposite each other in the outer part of the filtration element, the filtration element can be placed in a filtration module or system such that one of the tubes are arranged substantially at the top of the element while the other tube is arranged substantially at the bottom. This way ventilation can be achieved through the top tube, while the additional bottom tube increases output volume at a constant pressure.

In another embodiment the filtration element further comprises a perforated tube arranged around the membrane element, in particular composing at least one membrane arrangement comprising at least one hollow fiber membrane. The perforations may be formed by holes or other openings located in regular or irregular distances along the tube. Preferably, the membrane element, in particular the membrane arrangement is enclosed by the perforated tube.

With the perforated tube the axial pressure distribution along the filtration element can be equalized in filtration and back washing operation. Thus, the permeate flow is evenly distributed along the filtration element and hence the filtering effect can be increased.

In another embodiment the perforated tube is arranged such that an annular gap is formed between the element housing and the perforated tube. Known membrane elements do not have a distinct border and the membrane element are directly embedded in a housing of the filtration element. This leads to an uneven pressure distribution in axial direction as the axial flow is disturbed by the membrane element.

In another embodiment the membrane element comprises multibore membranes. The multibore membranes preferably comprise more than one capillary, which runs in a channel along the longitudinal axis of the membrane element or the filtration element. Particularly, the multibore membrane comprises at least one substrate forming the channels and at least one active layer arranged in the channels forming the capillaries. Embedding the capillaries within a substrate allows forming a multibore membrane, which are considerably easier to mount and mechanically more stable than membranes based on single hollow fibers. As a result of the mechanical stability, the multibore membrane is particularly suitable for cleaning by back washing, where the filtration direction is reversed such that a possible fouling layer formed in the channels is lifted and can be removed. In combination with the arrangements of the permeate collecting tube leading to an even pressure distribution within the membrane element, the overall performance and stability of the filtration element is further enhanced.

In contrast to designs with a central discharge tube and single bore membranes, the distribution of the multibore membranes is advantageous in terms of producing lower pressure loss in both operational modes filtration and backwash. Such designs further increases stability of the capillaries by equalizing the flow or pressure distribution across the membrane element. Thus, such designs avoid adverse effects on the pressure distribution among the capillaries of the membrane element. For designs with a central permeate collecting tube permeate flows in filtration mode from the outer capillaries of the membrane to the inner capillaries and has to pass a decreasing cross-section. In backwashing mode the effect reverses in that sense, that the flow volume decreases towards the outer capillaries and thus the cleaning effect decreases towards the outside as well. In fact the uneven flow and pressure distribution within the membrane element leads to the outer capillaries having a higher flow in filtration mode and hence building up more fouling layer than the inner capillaries. In backwashing mode, however, this reverses to the contrary with a higher cleaning effect for the inner capillaries, while the outer exhibit a higher build up. Thus the combination of the permeate collecting tube in the outer part of the filtration element and the use of the multi-bore membrane synergistically lead to a higher long-term stability of the filtration element.

Another aspect of the invention are membrane modules comprising membranes or membrane elements according to the invention.

In one embodiment, membrane modules according to the invention comprise a filtration element which is arranged within a module housing. The raw water is at least partly filtered through the filtration element and permeate is collected inside the filtration module and removed from the filtration module through an outlet. In one embodiment the filtrate (also referred to as “permeate”) is collected inside the filtration module in a permeate collection tube. Normally the element housing, optionally the permeate collecting tube and the membrane arrangement are fixed at each end in membrane holders comprising a resin, preferably an epoxy resin, in which the filtration element housing, the membranes, preferably multibore membranes, and optionally the filtrate collecting tube are embedded.

Membrane modules can in one embodiment for example have cylindrical shape, wherein the cross-section can have any shape such as round, oval, triangular, square or some polygon shape. Preferred is a round shape, which leads to a more even flow and pressure distribution within the membrane element and avoids collection of filtered material in certain areas such as corners for e.g. square or triangular shapes.

In one embodiment, membrane modules according to the invention have an inside-out configuration (“inside feed”) with the filtrate flowing from the inside of a hollow fiber or multibore membrane to the outside.

In one embodiment, membrane modules according to the invention have an outside-in filtration configuration (“outside feed”).

In a preferred embodiment, membranes, filtration elements, filtration modules and filtration systems according to the invention are configured such that they can be subjected to backwashing operations, in which filtrate is flushed through membranes in opposite direction to the filtration mode.

In one embodiment, membrane modules according to the invention are encased.

In another embodiment, membrane modules according to the invention are submerged in the fluid that is to be subjected to filtration.

In one embodiment, membranes, filtration elements, filtration modules and filtration systems according to the invention are used in membrane bioreactors.

In one embodiment, membrane modules according to the invention have a dead-end configuration and/or can be operated in a dead-end mode.

In one embodiment, membrane modules according to the invention have a crossflow configuration and/or can be operated in a crossflow mode.

In one embodiment, membrane modules according to the invention have a directflow configuration and/or can be operated in a directflow mode.

In one embodiment, membrane modules according to the invention have a configuration that allow the module to be cleaned and scoured with air.

In one embodiment, filtration modules include a module housing, wherein at least one filtration element as described above is arranged within the module housing. Hereby the filtration element is arranged vertically or horizontally. The module housing is for instance made of fiber reinforced plastic (FRP) or stainless steel.

In one embodiment the at least one filtration element is arranged within the module housing such that the longitudinal center axis of the filtration element and the longitudinal center axis of the housing are superimposed. Preferably the filtration element is enclosed by the module housing, such that an annular gap is formed between the module housing and the element housing.

The annular gap between the element housing and the module housing in operation allow for an even pressure distribution in axial direction along the filtration module.

In another embodiment the filtration element is arranged such that the at least one permeate collecting tube is located substantially at the top of the filtration module or filtration element. In this context substantially at the top includes any position in the outer part of the membrane element that lies within ±45°, preferred ±10°, particularly preferred ±5° from a vertical center axis in a transverse plane of the filtration element. Furthermore, the vertical center axis in a transverse plane is perpendicular to the horizontal center axis in the transverse plane and to the longitudinal center axis extending along the long axis of the filtration element. By arranging the permeate collecting tube this way, air residing within the filtration module or system before start up can be collected in the permeate collecting tube, which can then easily be vented upon start up by starting the filtration operation. In particular, air pockets can be displaced by permeate, which is fed to the filtration module or system on start up. By releasing air from the filtration module or system the active area of the membrane element is increased, thus increasing the filtering effect. Furthermore, the risk of fouling due to trapped air pockets decreases. Further preferred the filtration module is mount horizontally in order to orientate the permeate collecting tube accordingly.

In another embodiment the filtration element is arranged such that at least two permeate collecting tubes are arranged opposite each other in the outer part of the filtration element. In this embodiment the filtration module can be oriented such that one of the permeate collecting tubes are arranged substantially at the top of the filtration element, while the other tube is arranged substantially at the bottom of the filtration element. This way the ventilation can be achieved through the top tube, while the bottom tube allows for a higher output volume at a constant pressure. Furthermore, the permeate collecting tubes can have smaller dimensions compared to other configurations providing more space to be filled with the membrane element and thus increasing the filtration capacity.

In one embodiment, membrane modules according to the invention can have a configuration as disclosed in WO 2010/121628, S. 3, Z. 25 to p. 9, In 5 and especially as shown in FIG. 2 and FIG. 3 of WO 2010/121628.

In one embodiment membrane modules according to the invention can have a configuration as disclosed in EP 937 492, [0003] to [0020].

In one embodiment membrane modules according to the invention are capillary filtration membrane modules comprising a filter housing provided with an inlet, an outlet and a membrane compartment accommodating a bundle of membranes according to the invention, said membranes being cased at both ends of the membrane module in membrane holders and said membrane compartment being provided with discharge conduits coupled to the outlet for the conveyance of the permeate. In one embodiment said discharge conduits comprise at least one discharge lamella provided in the membrane compartment extending substantially in the longitudinal direction of the filtration membranes.

Another aspect of the invention are filtration systems comprising membrane modules according to the invention. Connecting multiple filtration modules normally increases the capacity of the filtration system. Preferably the filtration modules and the encompassed filtration elements are mounted horizontally and adapters are used to connect the filtration modules accordingly.

In one embodiment, filtration systems according to the invention comprise arrays of modules in parallel.

In one embodiment, filtration systems according to the invention comprise arrays of modules in horizontal position.

In one embodiment, filtration systems according to the invention comprise arrays of modules in vertical position.

In one embodiment, filtration systems according to the invention comprise a filtrate collecting vessel (like a tank, container).

In one embodiment, filtration systems according to the invention use filtrate collected in a filtrate collecting tank for backwashing the filtration modules.

In one embodiment, filtration systems according to the invention use the filtrate from one or more filtration modules to backwash another filtration module.

In one embodiment, filtration systems according to the invention comprise a filtrate collecting tube.

In one embodiment, filtration systems according to the invention comprise a filtrate collecting tube to which pressurized air can be applied to apply a backwash with high intensity.

In one embodiment, filtration systems according to the invention have a configuration as disclosed in EP 1 743 690, col. 2, ln. 37 to col. 8, ln. 14 and in FIG. 1 to FIG. 11 of EP 1 743 690; EP 2 008 704, col. 2, ln. 30 to col. 5, ln. 36 and FIG. 1 to FIG. 4; EP 2 158 958, col. 3, ln. 1 to col. 6, ln. 36 and FIG. 1.

In one embodiment filtration systems according to the invention comprise more than one filtration modules arranged vertically in a row, on both of whose sides an inflow pipe is arrayed for the fluid to be filtered and which open out individually allocated collecting pipes running lengthwise per row, whereby each filtration module has for the filtrate at least one outlet port which empties into a filtrate collecting pipe, whereby running along the sides of each row of filtration modules is a collecting pipe that has branch pipes allocated to said pipe on each side of the filtration module via which the allocated filtration module is directly connectable, wherein the filtrate collecting pipe runs above and parallel to the upper two adjacent collecting pipes.

In one embodiment, filtration systems according to the invention comprise a filtrate collecting pipe that is connected to each of the filtration modules of the respective filtration system and that is designed as a reservoir for backwashing the filtration system, wherein the filtration system is configured such that in backwashing mode pressurized air is applied to the filtrate collecting pipe to push permeate water from the permeate collecting pipe through the membrane modules in reverse direction.

In one embodiment, filtration systems according to the invention comprise a plurality of module rows arranged in parallel within a module rack and supplyable with raw water through supply/drain ports and each end face via respectively associated supply/drain lines and each including a drain port on a wall side for the filtrate, to which a filtrate collecting line is connected for draining the filtrate, wherein valve means are provided to control at least one filtration and backwashing mode, wherein, in the backwashing mode, a supply-side control valve of the first supply/drain lines carrying raw water of one module row is closed, but an associated drain-side control valve of the other supply/drain line of one module row serving to drain backwashing water is open, whereas the remaining module rows are open, to ensure backwashing of the one module row of the module rack by the filtrate simultaneously produced by the other module rows.

Hereinafter, when reference is made to the use of “membranes” for certain applications, this shall include the use of the membranes as well as filtration elements, membrane modules and filtration systems comprising such membranes and/or membrane modules.

Another aspect of the invention is the use of membranes M.

In a preferred embodiment, membranes M are used for the treatment of sea water or brackish water or surface water.

In one preferred embodiment of the invention, membranes according to the invention, particularly RO, FO or NF membranes are used for the desalination of sea water or brackish water.

Membranes M, particularly RO, FO or NF membranes are used for the desalination of water with a particularly high salt content of for example 3 to 8% by weight. For example membranes M are suitable for the desalination of water from mining and oil/gas production and fracking processes, to obtain a higher yield in these applications.

Different types of membrane M can also be used together in hybrid systems combining for example RO and FO membranes, RO and UF membranes, RO and NF membranes, RO and NF and UF membranes, NF and UF membranes.

In another preferred embodiment, membranes M, particularly NF, UF or MF membranes are used in a water treatment step prior to the desalination of sea water or brackish water.

In another preferred embodiment membranes M, particularly NF, UF or MF membranes are used for the treatment of industrial or municipal waste water.

Membranes M, particularly RO and/or FO membranes can be used in food processing, for example for concentrating, desalting or dewatering food liquids (such as fruit juices), for the production of whey protein powders and for the concentration of milk, the UF permeate from making of whey powder, which contains lactose, can be concentrated by RO, wine processing, providing water for car washing, making maple syrup, during electrochemical production of hydrogen to prevent formation of minerals on electrode surface, for supplying water to reef aquaria.

Membranes M, particularly UF membranes can be used in medical applications like in dialysis and other blood treatments, food processing, concentration for making cheese, processing of proteins, desalting and solvent-exchange of proteins, fractionation of proteins, clarification of fruit juice, recovery of vaccines and antibiotics from fermentation broth, laboratory grade water purification, drinking water disinfection (including removal of viruses), removal of endocrines and pesticides combined with suspended activated carbon pretreatment.

Membranes M, particularly RO, FO, NF membranes can be used for rehabilitation of mines, homogeneous catalyst recovery, desalting reaction processes.

Membranes M, particularly NF membranes, can be used for separating divalent ions or heavy and/or radioactive metal ions, for example in mining applications, homogeneous catalyst recovery, desalting reaction processes.

### EXAMPLES

Abbreviations used in the examples and elsewhere:
NMP N-methylpyrrolidone
DMAc Dimethylacetamide
PWP pure water permeation
MWCO molecular weight cutoff
DMF dimethylformamide
THF tetrahydrofurane
PESU polyethersulfone
Ultrason® E 6020P polyethersulfone with a viscosity number (ISO 307, 1157, 1628; in 0.01 g/mol phenol/1,2 orthodichlorobenzene 1:1 solution) of 82; a glass transition temperature (DSC, 10° C./min; according to ISO 11357-1/-2) of 225° C.; a molecular weight Mw (GPC in DMAc, PMMA standard): 75000 g/mol
Ultrason® E 7020P polyethersulfone with a viscosity number (ISO 307, 1157, 1628; in 0.01 g/mol phenol/1,2 orthodichlorobenzene 1:1 solution) of 105; a glass transition temperature (DSC, 10° C./min; according to ISO 11357-1/-2) of 225° C.; a molecular weight Mw (GPC in DMAc, PMMA standard): 92000 g/mol
Luvitec® K90 Polyvinylpyrrolidone with a solution viscosity characterized by the K-value of 90, determined according to the method of Fikentscher (Fikentscher, Cellulosechemie 13, 1932 (58))
Luvitec® K30 Polyvinylpyrrolidone with a solution viscosity characterized by the K-value of 30, determined according to the method of Fikentscher (Fikentscher, Cellulosechemie 13, 1932 (58))
POLYOX™ WSR-N10 Polyethyleneoxide with a solution viscosity characterized by the K-value of 68, determined according to the method of Fikentscher (Fikentscher, Cellulosechemie 13, 1932 (58)) and a molecular weight Mw (GPC in water, polyethyleneoxide standard): 102000 g/mol
POLYOX™ WSR-N80 Polyethyleneoxide with a solution viscosity characterized by the K-value of 84, determined according to the method of Fikentscher (Fikentscher, Cellulosechemie 13, 1932 (58)) and a molecular weight Mw (GPC in water, polyethyleneoxide standard): 187000 g/mol
POLYOX™ WSR-N750 Polyethyleneoxide with a solution viscosity characterized by the K-value of 109, determined according to the method of Fikentscher (Fikentscher, Cellulosechemie 13, 1932 (58)) and a molecular weight Mw (GPC in water, polyethyleneoxide standard): 456000 g/mol
Pluriol® 9000E Polyethyleneoxide with a solution viscosity characterized by the K-value of 33, determined according to the method of Fikentscher (Fikentscher, Cellulosechemie 13, 1932 (58)) and a molecular weight Mw (GPC in water, polyethyleneoxide standard): 10800 g/mol
Breox® 75W55000 Polyethyleneoxide-polypropyleneoxide copolymer with a solution viscosity characterized by the K-value of 42, determined according to the method of Fikentscher (Fikentscher, Cellulosechemie 13, 1932 (58)) and a molecular weight Mw (GPC in water, polyethyleneoxide standard): 14300 g/mol

The molecular weight distribution and the average molecular weight of the polyalkyleneoxide polymers obtained were determined by GPC measurements. GPC-measurements were done using water as solvent. After filtration (pore size 0.2 μm), 100 μl of this solution was injected in the GPC system. For the separation two hydroxylated polymethacrylate columns (TSKgel GMPWXL, 30 cm) were used. The system was operated with a flow rate of 0.8 ml/min at 35° C. As detection system an RI-detector was used (DRI Agilent 1100). The calibration was carried out with polyethyleneoxide-standards (company Polymer Labs, Agilent easy vial) with molecular weights in the range from 106 to 1.522.000 g/mol.

The molecular weight distribution and the average molecular weight of the polyvinylpyrrolidone polymer obtained were determined by GPC measurements. GPC-measurements were done using acetonitrile/water (20/80 vol/vol) as solvent. After filtration (pore size 0.2 μm), 100 μl of this solution was injected in the GPC system. For the separation two Suprema-Gel (HEMA) columns (Suprema linear S and XL, 30 cm) were used. The system was operated with a flow rate of 0.8 ml/min at 35° C. As detection system an RI-detector was used (DRI Agilent 1100). The calibration was carried out with polyvinylpyrrolidone-Standards (company Polymer American Standards) with molecular weights in the range from 4.300 to 1.065.000 g/mol.

The pure water permeation (PWP) of the membranes was tested using a pressure cell with a diameter of 60 mm using ultrapure water (salt-free water, filtered by a Millipore UF-system). In a subsequent test, a solution of different PEG-Standards was filtered at a pressure of 0.15 bar. By GPC-measurement of the feed and permeate, the molecular weight cut-off of the membranes were determined.

### Examples 1 to 8: Preparation of Membranes

Into a three neck flask equipped with a magnetic stirrer there were added 75 ml of N-methylpyrrolidone, 6 parts of dope polymer DP1 as named in table 1 and 19 g of polymer P. The mixture was heated under gentle stirring at 60° C. until a homogeneous clear viscous solution was obtained. The solution was degassed overnight at room temperature. After that the membrane solution was reheated at 60° C. for 2 hours and casted onto a glass plate with a casting knife (300 microns) at 60° C. using an Erichsen Coating machine operating at a speed of 5 mm/min. The membrane film was allowed to rest for 30 seconds before immersion in a water bath at 25° C. for 10 minutes.

After the membrane had detached from the glass plate, the membrane was carefully transferred into a water bath for 12 h. Afterwards the membrane was transferred into a bath containing 2500 ppm NaOCl at 50° C. for 4.5 h to remove PVP. The membrane was then washed with water at 60° C. and one time with a 0.5 wt.-% solution of sodium bisulfite to remove active chlorine. After several washing steps with water the membrane was stored wet until characterization regarding pure water permeability (PWP) and minimum pore size (MWCO) started.

The amount of polyethyleneoxide remaining in the processed membranes (PEO content) is estimated by the means of ¹H-NMR spectroscopy (400 MHz). The dried membrane samples are dissolved in CDCl3 and trifluoroacetic acid (TFA) and analyzed by the means of signal intensity for PEO at 3.7 ppm (—CH₂CH₂—O—, 4H) and the Ultrason E repetition unit at 7.3 ppm and 7.9 ppm (aromatic, 8H). With the molecular weights of the repetition units (M_{Ultrason}=232.26 g/mol, M_{PEO}=44.05 g/mol), the corresponding shares are assessed and the PEO content is calculated according to:

PEO content[%]=[m_{PEO}/(m_{PEO}+m_{Ultrason})]*100

TABLE 1
Compositions and properties of membranes prepared according to
examples 1 to 8; MWCO in [Da], PWP in [kg/h m²bar].

| | Polymer P | DP1 | PEO content [%] | PWP | MWCO |
|---|---|---|---|---|---|
| 1 | E7020 | K90 | 0 | 490 | 45100 |
| 2 | E7020 | N10 | 9.7 | 585 | 11200 |
| 3 | E7020 | N80 | 10.6 | 570 | 9580 |
| 4 | E7020 | N750 | 11.3 | 443 | 9350 |
| 5 | E6020 | K90 | 0 | 510 | 42400 |
| 6 | E6020 | N10 | 15.6 | 400 | 12800 |
| 7 | E6020 | N80 | 16.6 | 330 | 6600 |
| 8 | E6020 | N750 | 12.4 | 500 | 11000 |

### Examples 9 to 22: Preparation of Membranes

Into a three neck flask equipped with a magnetic stirrer there were added 75 ml of N-methylpyrrolidone, 6 parts of dope polymer DP1 and second dope polymer DP2 as named in table 2 and 19 g of polyethersulfone Ultrason® E6020P. The mixture was heated under gentle stirring at 60° C. until a homogeneous clear viscous solution was obtained. The solution was degassed overnight at room temperature. After that the membrane solution was reheated at 60° C. for 2 hours and casted onto a glass plate with a casting knife (300 microns) at 60° C. using an Erichsen Coating machine operating at a speed of 5 mm/min. The membrane film was allowed to rest for 30 seconds before immersion in a water bath at 25° C. for 10 minutes.

After the membrane had detached from the glass plate, the membrane was carefully transferred into a water bath for 12 h. Afterwards the membrane was transferred into a bath containing 2500 ppm NaOCl at 50° C. for 4.5 h to remove the second dope (PT “NaOCl”). The membrane was then washed with water at 60° C. and one time with a 0.5 wt.-% solution of sodium bisulfite to remove active chlorine. As alternative, the membranes so obtained were washed six times with water, referred to as “H2O”. After several washing steps with water the membrane was stored wet until characterization regarding pure water permeability (PWP) and minimum pore size (MWCO) and PEO content started.

TABLE 2
Compositions and properties of membranes prepared according to
examples 9 to 22; MWCO in [Da], PWP in [kg/h m²bar].

| | DP1 | DP2 | | PEO | | |
|---|---|---|---|---|---|---|
| | (name, amount | (name, amount | | content | | |
| | [parts]) | [parts]) | PT | [%] | PWP | MWCO |
| 9 | K90, 6 | — | H2O | 0 | 82 | 7180 |
| 10 | K90, 6 | — | NaOCl | 0 | 510 | 42400 |
| 11 | N750, 1 | E9000, 5 | H2O | 13.3 | 63 | 15300 |
| 12 | N750, 1 | E9000, 5 | NaOCl | 12.7 | 90 | 11300 |
| 13 | N750, 2 | E9000, 4 | H2O | 14.6 | 185 | 18500 |
| 14 | N750, 2 | E9000, 4 | NaOCl | 11.9 | 290 | 13800 |
| 15 | N750, 3 | E9000, 3 | H2O | 14.9 | 285 | 16950 |
| 16 | N750, 3 | E9000, 3 | NaOCl | 11.4 | 525 | 13000 |
| 17 | N750, 4 | E9000, 2 | H2O | 16.1 | 133 | 18000 |
| 18 | N750, 4 | E9000, 2 | NaOCl | 12.3 | 450 | 13100 |
| 19 | N750, 6 | — | H2O | 15.7 | 51 | 12300 |
| 20 | N750, 6 | — | NaOCl | 12.4 | 500 | 11000 |
| 21 | N750, 3 | Breox, 3 | H2O | 13.5 | 130 | 19600 |
| 22 | N750, 3 | Breox, 3 | NaOCl | 12.1 | 800 | 15500 |

From tables 1 and 2 it can be seen that the inventive membranes have comparable pure water permeability values but clearly lower MWCO below 20 kDa compared to examples 5 and 10. For post treatment with water (PT H2O) the inventive membranes have significantly higher PWP's compared to example 9 but maintain MWCO values below 20 kDa.

### Examples 23 to 26: Evaluation of the Fouling Behavior of Membranes

For the assessment of fouling tendency the pure water permeation (PWP₀) of the membranes obtained according to examples 5, 6, 7 and 16 was tested using a pressure cell with a diameter of 60 mm using ultrapure water (salt-free water, filtered by a Millipore UF-system). Then, a solution of different PEG-Standards was filtered at a pressure of 0.15 bar. Finally, the pure water permeation (PWP_{PEO}) of the membrane was tested again and the Fouling index (FI) calculated according to:

FI=[PWP₀/PWP_{PEO}]

TABLE 3
Fouling index and properties of selected
Ultrason ® E6020P membranes prepared according
to previous examples; MWCO in [Da], PWP in [kg/h m²bar].

| | | DP1 | DP2 | | | | |
|---|---|---|---|---|---|---|---|
| | Membrane | (name, | (name, | | | | |
| | used (Ex. | amount | amount | | | | |
| | No.) | [parts]) | [parts]) | PT | FI | PWP | MWCO |
| 23 | 5 | K90, 6 | — | NaOCl | 12.0 | 510 | 42400 |
| 24 | 6 | N10, 6 | — | NaOCl | 4.2 | 400 | 12800 |
| 25 | 7 | N80, 6 | — | NaOCl | 5.7 | 330 | 6600 |
| 26 | 16 | N750, 3 | E9000, 3 | NaOCl | 6.0 | 525 | 13000 |

No fouling is observed for a fouling index of FI=1. Table 3 shows for the reference membrane (example 23) a significant higher FI than for the inventive membranes (FI=4.2 to 6) from examples 24 to 26.

1. A membrane M, comprising a polymer composition comprising
a) at least one polymer P selected from the group consisting of polyamide (PA), polyvinylalcohol (PVA), Cellulose Acetate (CA), Cellulose Triacetate (CTA), CA-triacetate blend, Cellu-lose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copol-ymer, polyetherimide (PEI), Polyetheretherketone (PEEK), sulfonated polyetheretherketone (SPEEK), Poly(dimethylphenylene oxide) (PPO), Polycarbonate, Polyester, Polytetrafluroethylene (PTFE), Poly(vinylidene fluoride) (PVDF), Pol-ypropylene (PP), Polyelectrolyte complex, Poly(methyl methacrylate) PMMA, Polydimethylsiloxane (PDMS), aromatic, aromatic/aliphatic or aliphatic polyimide urethane, aromatic, aromatic/aliphatic or aliphatic polyamidimide, crosslinked polyimide or polyarylene ether, polysulfone (PSU), polyphenylenesulfone (PPSU) and polyethersulfone (PESU), and
b) at least one dope polymer DP1, which is a poly-alkylene oxide with a molecular mass M_{W} of more than 100,000 g/mol and/or a K-value of 60 or more.

2. The membrane according to claim 1, wherein said polymer P is at least one selected from the group consisting of Poly(vinylidene fluoride) (PVDF), polyarylene ether, polysulfone (PSU), polyphenylenesulfone (PPSU) and polyethersulfone (PESU).

3. The membrane according to claim 1, wherein said dope polymer DP1 is present in an amount of 0.1 to 20% by weight relative to a total weight of the membrane M.

4. The membrane according to claim 1, wherein said polymer composition further comprises at least one second dope polymer DP2 selected from the group consisting of polyalkylene oxide with a molecular mass M_{W} below 100,000 g/mol and/or a K-value of less than 60, and polyvinylpyrrolidone.

5. The membrane according to claim 4, wherein said second dope polymer DP2 is present in an amount of 0.1 to 19.9% by weight relative to a total weight of the membrane M with the proviso that a combined amount of said dope polymer DP1 and said second dope polymer DP2 is from 0.2% by weight to 20% by weight.

6. The membrane according to claim 1, wherein said membrane M is an ultrafiltration membrane, a microfiltration membrane or a carrier of a reverse osmosis membrane or forward osmosis membrane.

7. A process for making a membrane M, the process comprising:
a) providing a dope solution D comprising at least one polymer P, at least one dope polymer DP1 and optionally at least one second dope polymer DP2 and at least one solvent S,
b) adding at least one coagulant C to said dope solution D to coagulate said at least one polymer P from said dope solution D to obtain the membrane M,
c) optionally performing an oxidative treatment of the membrane obtained in a) and b), and
d) optionally washing the membrane with water.

8. (canceled)

9. A membrane element, comprising the membrane according to claim 1.

10. A membrane module, comprising the membranes the membrane according to claim 1.

11. A filtration system, comprising the membrane element according to claim 9.

12. A filtration system, comprising the membrane module according to claim 10.
